(19) United States
(12) Patent Application Publication
(10) Pub. No.: US 2023/0159357 A1
(43) Pub. Date: May 25, 2023

(54) ParaDice Process System

(71) Applicant: James Lamar Dice, Greenville, FL (US)

(72) Inventor: James Lamar Dice, Greenville, FL (US)

(21) Appl. No.: 17/593,853

(22) PCT Filed: Mar. 21, 2021
(86) PCT No.: PCT/US21/23368

§ 371 Date: Sep. 27, 2021

(51) Int. Cl. C02F 1/46; C02F 1/00; C02F 1/62

(52) U.S. Cl. CPC C02F 1/4604; C02F 1/004; C02F 1/62; C02F 2001/007; C02F 2101/20

(57) ABSTRACT

The ParaDice Process System is the interconnection of a renewable power source to power an ocean water electrolysis apparatus comprising a water container, an electrolysis cell, optionally a precious metal harvesting probe, a filtration system, and a settlement pond wherein the hydrogen generated as a result of electrolysis is supplied to either a hydrogen combustion engine or hydrogen turbine to power an electricity generator thereby creating a renewable zero carbon emission electric power generation system. The hydrogen gas is collected by a chlorine scrubber and transferred to either a hydrogen combustion engine or a hydrogen turbine. Where a hydrogen turbine is embodied the waste heat created therein is used to generate electricity and increase the performance of the filtration system and settlement pond.

### TECHNICAL FIELD OF THE INVENTION

This invention relates generally to a ParaDice Process System (power generation system) in the form of an interconnected sequence of zero carbon emission devices and apparatuses to use the output of renewable power source, such as a solar or wind electric power generator, to power electrolysis whose hydrogen off gassing is used to power a hydrogen combustion engine and produce carbon emission free electric power for a home, business, municipality, state, or sovereign.

This invention relates specifically to a power generation system as above that is capable of providing hydrogen generated power, a chlorine supply, a potable water supply, and precious metals. The invention relates specifically to scalable production of zero carbon emission renewable electric power ranging in system size from servicing a home based hydroponics grow system all the way to a system sized to power a nation.

### BACKGROUND

Among the existing art available today are several zero carbon emission electricity generating technologies. Today there are existing solar collection devices that can generate electricity, and there are wind collection devices that can generate electricity neither of which emit carbon while producing electricity. There are also hydrogen powered combustion engines and hydrogen powered turbines which operate on hydrogen and do not produce carbon emissions.

In light of the foregoing prior art, there is a need for a power generation system that combines these zero carbon emission technologies with an electrolysis cell to create the hydrogen for the hydrogen based engines and turbines to generate electricity.

### BRIEF SUMMARY OF THE INVENTION

According to a first aspect of the invention, there is a ParaDice Process System power generating apparatus comprising a first renewable power source, a first water holding container having installed within a plurality of electrolysis cells, a filtration system, and a settlement pond, a first chlorine scrubber, a first hydrogen tank, a first chlorine tank, a first hydrogen combustion engine, a first water tank, a first electricity generator, a first transformer, and a first electrical transfer switch wherein said water holding container is filled with a volume of ocean water equal to more than half of the volume of said water holding tank enabling an electrolysis of said ocean water and chlorine scrubbing to produce hydrogen enabling the operation of said hydrogen combustion engine thereby operating said electricity generator to produce, transform, switch an electric power supply herein produced.

According to a second aspect of the invention, there is a ParaDice Process System power generating apparatus wherein said water holding container further comprises, operationally installed within, a plurality of precious metal harvesting probes enabling a collection of precious metals.

According to a third aspect of the invention, there is a ParaDice Process System power generating apparatus further comprising a plurality of battery storage devices enabling an electrical power storage.

According to a fourth aspect of the invention, there is a ParaDice Process System power generating apparatus further comprising a plurality of renewable power sources, a plurality of battery storage devices, a plurality of water holding containers having installed within a plurality of electrolysis cells, a plurality of precious metal harvesting probes, a filtration system, and a settlement pond, a plurality of chlorine scrubbers, a plurality of hydrogen tanks, a plurality of chlorine tanks, a plurality of hydrogen combustion engines, a plurality of water tanks, a plurality of electricity generators, a plurality of transformers, and a plurality of electrical transfer switches enabling an increase in electric power supply herein produced.

According to a fifth aspect of the invention, there is a ParaDice Process System power generating apparatus wherein said hydrogen combustion engine is instead a hydrogen gas turbine engine enabling said electric power supply and a heat source to increase efficiency of said filtration system and said settlement pond.

According to a sixth aspect of the invention, there is a ParaDice Process System power generating apparatus method of using said system to generate a renewal electrical energy for a home, business, hydroponic grow house, a military base, a refuge camp, and/or an island nation electrically powered by said apparatus.

According to a seventh aspect of the invention, there is a ParaDice Process System power generating apparatus further comprising a method to create chlorine, potable water, precious metals, salt, and/or hydrogen.

According to an eighth aspect of the invention, there is a ParaDice Process System power generating apparatus used to provide live load stand-by/back-up electrical power.

According to a ninth aspect of the invention, there is a ParaDice Process System method of carbon emission free energy generation and storage, including utilizing a power source to generate electricity carbon emission free, providing the electricity to an ocean water electrolysis apparatus to produce a mixture of hydrogen and chlorine, channeling the mixture to a chlorine scrubber to separate the hydrogen and chlorine, and providing the chlorine and hydrogen separately to chlorine storage tank and a hydrogen storage tank, including providing the electricity to the battery storage device via a transfer switch electrically intermediate the power source and the battery, and including providing the ocean water to a water container in which the ocean water is hydrolyzed.

According to a tenth aspect of the invention, there is a ParaDice Process System method of carbon emission free energy generation and storage according to the ninth aspect including providing the electricity from the power source to a battery to charge the battery, and wherein providing the electricity to the ocean water electrolysis apparatus includes utilizing the battery to provide the electricity. This aspect may also include maintaining the water container more than half full while hydrolyzing the ocean water inside, concentrating a substance in ocean water in the water container by hydrolyzing the ocean water in water container, utilizing a filtration system in the water container to filter out the substance which has been concentrated, producing the mixture of hydrogen and chlorine in the water container on an electrode of the ocean water electrolysis apparatus, collecting salt in a settlement pond from the ocean water in the water container, channeling the mixture from water the container to the chlorine scrubber, providing the hydrogen as a fuel to an internal combustion or turbine engine to generate power, providing heat from the internal combustion or turbine engine to a water container to warm the ocean water inside, utilizing the internal combustion or turbine engine to drive an electricity generator, and opening a hydrogen use line intermediate the hydrogen storage tank and the internal combustion or turbine engine to provide the hydrogen.

According to an eleventh aspect of the invention, there is a ParaDice Process System to generate carbon emission free energy generation and separately store hydrogen and chlorine, comprising: a power source to generate electricity carbon emission free electrically connected to an ocean water electrolysis apparatus to produce a mixture of hydrogen and chlorine and a conduit fluidically connecting the ocean water electrolysis apparatus to channel the mixture a chlorine scrubber to separate the hydrogen and chlorine and a chlorine storage tank and a hydrogen storage tank downstream of the chlorine scrubber.

An advantage of the ParaDice Process System power generating apparatus is the capability to generate electrical power with zero carbon emissions with the highly scalable combination as herein described.

The invention will now be described, by way of example only, with reference to the accompanying drawings in which:

### BRIEF DESCRIPTION OF THE DRAWINGS

FIG. 1 is a diagram of the ParaDice Process System power generating apparatus using the hydrogen combustion engine to continuously generate electrical power according to the invention;

FIG. 2 is a diagram of the ParaDice Process System power generating apparatus using the hydrogen turbines to continuously generate electrical power and recycle the extra heat for enhancing electrolysis, filtration, gas scrubbing, and waste heat power generation according to the invention.

### DETAILED DESCRIPTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

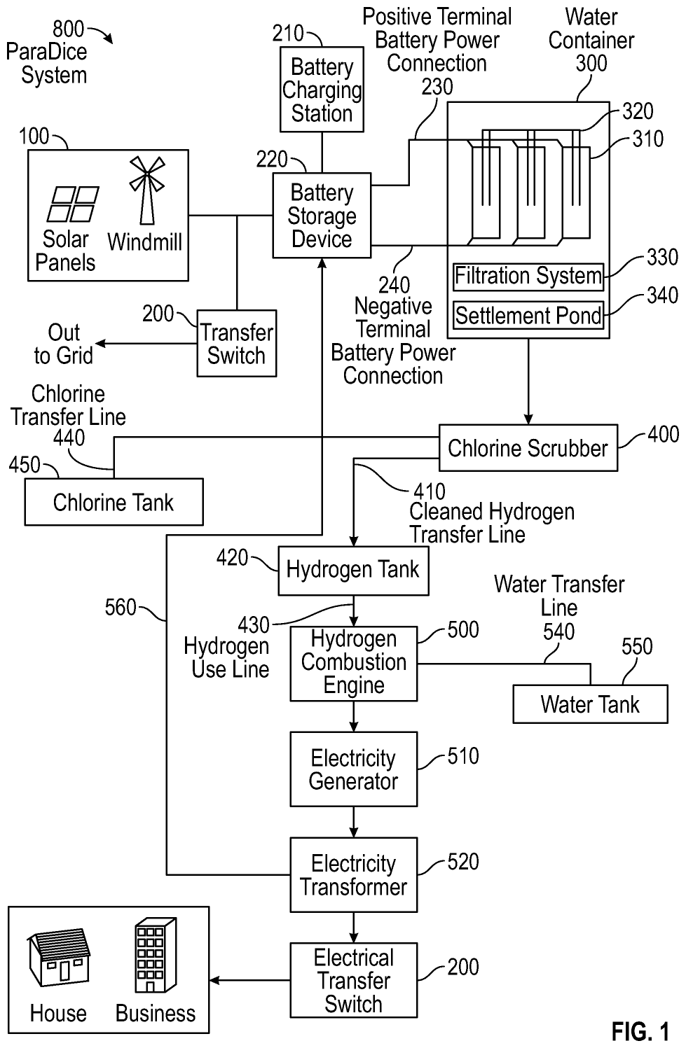

Referring to the Figures, there is shown in FIG. 1, the following:

Index of Labelled Features in Figures (numeric order).

Element 100 is a renewable power source (e.g. solar, wind, wave).

Element 200 is an electric transfer switch (e.g. electric grid type).

Element 210 is a battery charging station.

Element 220 is a battery storage device.

Element 230 is a positive terminal battery power connection.

Element 240 is a negative terminal battery power connection.

Element 300 is a water holding container.

Element 310 is an electrolysis cell.

Element 320 is a precious metal harvesting probe.

Element 330 is a filtration system.

Element 340 is a settlement pond.

Element 400 is a chlorine scrubber.

Element 410 is cleaned hydrogen transfer line.

Element 420 is a hydrogen gas tank.

Element 430 is a hydrogen use line.

Element 440 is a chlorine transfer line.

Element 450 is a chlorine tank.

Element 500 is a hydrogen combustion engine.

Element 510 is an electricity generator.

Element 520 is an electricity transformer.

Element 200 is an electrical transfer switch.

Element 540 is a water transfer line.

Element 550 is a water tank.

Element 560 is a power line to battery line.

Element 800 is a ParaDice Process System.

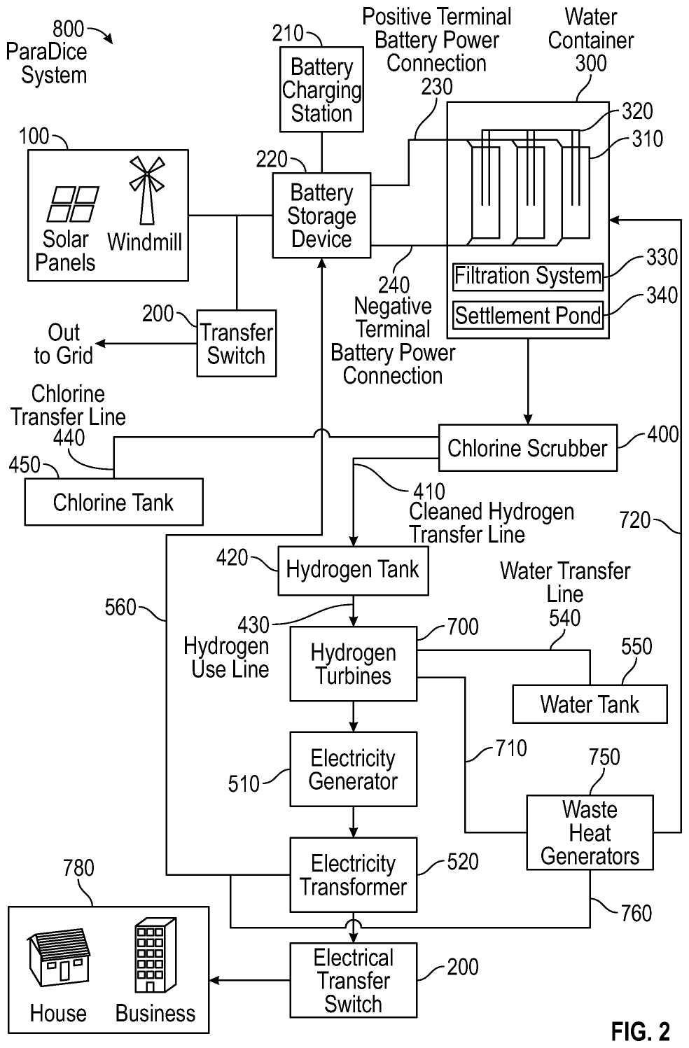

Referring to the Figures, there is shown in FIG. 2, the following:

Element 700 is a hydrogen turbine.

Element 710 is a hydrogen turbine to waste heat generator heat conduit.

Element 720 is a hydrogen turbine, or waste heat generator to water container heat conduit.

Element 750 is a waste heat generator.

Element 760 is a waste heat generator power output line.

Electrolysis is the passing of a direct electric current through an electrolyte to produce chemical reactions at the electrodes and decomposition of the materials. In the ParaDice Process System (800) ocean water is decomposed into its parts including any other chemicals and materials contained therein. Water is hydrogen and oxygen, and ocean water is water with added salt (sodium and chlorine) and other traces of many other elements suspended therein. Thus it is possible to extract hydrogen, oxygen, sodium, chlorine, and all other elements/minerals suspended within ocean water from ocean water.

The device/apparatus of the present invention is used to consume the electric energy of a renewable power source (100) within an ocean water electrolysis apparatus to create hydrogen, oxygen, sodium, chlorine, and collections of all of the other suspended elements/minerals contained within the ocean water. The other suspended elements include precious metals and chlorine which can be harvested by the inclusion of an appropriate precious metal harvest probe (320) to harvest a desired precious metal.

The renewable power source (100) may be comprised of, but is not limited to, any of the following: a solar power array creating direct current, or a windmill creating an electric current either direct or alternating and converted to direct current.

In an embodiment, the ParaDice Process System (800) is the interconnection of a renewable power source (100) to power an ocean water electrolysis apparatus shown in the figures as the combination of a water container (300), an electrolysis cell (310), optionally a precious metal harvesting probe (320), a filtration system (330), and a settlement pond (340) wherein the hydrogen generated as a result of electrolysis is supplied to either a hydrogen combustion engine (500) or hydrogen turbine (700) to power an electricity generator (510) thereby creating a renewable zero carbon emission electric power generation system.

The hydrogen gas is collected by a chlorine scrubber (400) and transferred to either a hydrogen combustion engine (500) or hydrogen turbine (700) via a connectively attached cleaned hydrogen transfer line (410) from a hydrogen tank (420) connected between. The chlorine scrubber (400) also produces chlorine stored in a chlorine tank (450) and clean potable water stored in a water tank (550).

In an embodiment, the ParaDice Process System (800) uses the hydrogen as fuel for hydrogen turbines (700) that can supply the power to operate electricity generators (510). Additionally, when the present invention is embodied with a hydrogen turbine (700) it further provides a heat source that may be utilized in the electrolysis and filtration processes to speed up the water purification process and evaporation of water in the salt separation in a settlement pond (340).

Further, where the embodiment includes the use of a hydrogen turbine (700), a waste heat generator (750) may be added to capture and convert the heat created by the hydrogen turbine (700) into electrical energy transferred for storage or use by a waste heat generator power output line (760) to an electrical transfer switch (200) or a batter storage device (220).

In a preferred embodiment, there is a ParaDice Process System (800) power generating apparatus comprising a first renewable power source (100), a first water holding container (300) having installed within a plurality of electrolysis cells (310), a filtration system (330), and a settlement pond (340), a first chlorine scrubber (400), a first hydrogen tank (420), a first chlorine tank (450), a first hydrogen combustion engine (500), a first water tank (550), a first electricity generator (510), a first transformer (520), and a first electrical transfer switch (200) wherein said water holding container (300) is filled with a volume of ocean water equal to more than half of the volume of said water holding container (300) enabling an electrolysis of said ocean water and chlorine scrubbing to produce hydrogen enabling the operation of said hydrogen combustion engine thereby operating said electricity generator (510) to produce, transform, switch an electric power supply herein produced.

In an alternate embodiment, there is a ParaDice Process System (800) power generating apparatus wherein said water holding container (300) further comprises, operationally installed within, a plurality of precious metal harvesting probes (320) enabling a collection of precious metals.

In an alternate embodiment, there is a ParaDice Process System (800) power generating apparatus further comprising a plurality of battery storage devices (220) enabling an electrical power storage.

In an alternate embodiment, there is a ParaDice Process System (800) power generating apparatus that is highly scalable further comprising a plurality of renewable power sources (100), a plurality of battery storage devices (220), a plurality of water holding containers (300) having installed within a plurality of electrolysis cells (310), a plurality of precious metal harvesting probes (320), a filtration system (330), and a settlement pond (340), a plurality of chlorine scrubbers, (400) a plurality of hydrogen tanks (420), a plurality of chlorine tanks (450), a plurality of hydrogen combustion engines (500), a plurality of water tanks (550), a plurality of electricity generators, (510) a plurality of transformers (520), and a plurality of electrical transfer switches (200) enabling an increase in electric power supply therein produced to supply power for any electric demand.

In an alternate embodiment, there is a ParaDice Process System (800) power generating apparatus wherein said hydrogen combustion engine (500) is instead a hydrogen turbine (700) enabling said electric power supply and a heat source to increase efficiency of said chlorine scrubber (400), filtration system (330) and said settlement pond (340).

In an alternate embodiment, there is a ParaDice Process System (800) power generating apparatus method of using said system to generate a renewal electrical energy for a home, business, hydroponic grow house, a military base, a refuge camp, and/or an island nation electrically powered by said apparatus.

In an alternate embodiment, there is a ParaDice Process System (800) power generating apparatus further comprising a method to create chlorine, potable water, precious metals, salt, and/or hydrogen.

In an alternate embodiment, there is a ParaDice Process System (800) power generating apparatus used to provide live load stand-by/back-up electrical power.

In a preferred embodiment, there is a ParaDice Process System (800) power generating apparatus method of carbon emission free energy generation and storage, including utilizing a power source to generate electricity carbon emission free, providing the electricity to an ocean water electrolysis apparatus to produce a mixture of hydrogen and chlorine, channeling the mixture to a chlorine scrubber to separate the hydrogen and chlorine, and providing the chlorine and hydrogen separately to chlorine storage tank and a hydrogen storage tank.

In an alternate embodiment, there is a ParaDice Process System (800) power generating apparatus method of carbon emission free energy generation and storage, including providing the electricity from the power source to a battery to charge the battery.

In an alternate embodiment, there is a ParaDice Process System (800) power generating apparatus method of carbon emission free energy generation and storage, wherein providing the electricity to the ocean water electrolysis apparatus includes utilizing the battery to provide the electricity.

In an alternate embodiment, there is a ParaDice Process System (800) power generating apparatus method of carbon emission free energy generation and storage, including providing the electricity to the battery storage device via a transfer switch electrically intermediate the power source and the battery.

In an alternate embodiment, there is a ParaDice Process System (800) power generating apparatus method of carbon emission free energy generation and storage, including providing the ocean water to a water container in which the ocean water is hydrolyzed.

In an alternate embodiment, there is a ParaDice Process System (800) power generating apparatus method of carbon emission free energy generation and storage, including maintaining the water container more than half full while hydrolyzing the ocean water inside.

In an alternate embodiment, there is a ParaDice Process System (800) power generating apparatus method of carbon emission free energy generation and storage, including concentrating a substance in ocean water in the water container by hydrolyzing the ocean water in water container.

In an alternate embodiment, there is a ParaDice Process System (800) power generating apparatus method of carbon emission free energy generation and storage, including utilizing a filtration system in the water container to filter out the substance which has been concentrated.

In an alternate embodiment, there is a ParaDice Process System (800) power generating apparatus method of carbon emission free energy generation and storage, including producing the mixture of hydrogen and chlorine in the water container on an electrode of the ocean water electrolysis apparatus, collecting salt in a settlement pond from the ocean water in the water container, channeling the mixture from water the container to the chlorine scrubber, providing the hydrogen as a fuel to an internal combustion or turbine engine to generate power, providing heat from the internal combustion or turbine engine to a water container to warm the ocean water inside, utilizing the internal combustion or turbine engine to drive an electricity generator, and opening a hydrogen use line intermediate the hydrogen storage tank and the internal combustion or turbine engine to provide the hydrogen.

In an alternate embodiment, there is a ParaDice Process System (800) power generating apparatus method of carbon emission free energy generation and storage, wherein said system is configured to generate carbon emission free energy generation and separately store hydrogen and chlorine, comprising: a power source to generate electricity carbon emission free electrically connected to an ocean water electrolysis apparatus to produce a mixture of hydrogen and chlorine and a conduit fluidically connecting the ocean water electrolysis apparatus to channel the mixture a chlorine scrubber to separate the hydrogen and chlorine and a chlorine storage tank and a hydrogen storage tank downstream of the chlorine scrubber.

An advantage of the ParaDice Process System (800) power generating apparatus is the capability to generate electrical power with zero carbon emissions with the highly scalable combination as herein described. A ParaDice Process System (800) may be embodied in any size needed to supply any electrical demand. Examples include, but are not limited to, the following: a home, business, hydroponic grow house, a military base, a refuge camp, and/or an island nation

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A ParaDice Process System power generating apparatus comprising
a first renewable power source,
a first water holding container having installed within a plurality of electrolysis cells, a filtration system, and a settlement pond,
a first chlorine scrubber,
a first hydrogen tank,
a first chlorine tank,
a first hydrogen combustion engine,
a first water tank,
a first electricity generator,
a first transformer, and
a first electrical transfer switch
wherein said water holding container is filled with a volume of ocean water equal to more than half of the volume of said water holding tank enabling an electrolysis of said ocean water and chlorine scrubbing to produce hydrogen enabling the operation of said hydrogen combustion engine thereby operating said electricity generator to produce, transform, switch an electric power supply herein produced.

2. The apparatus of claim 1 wherein said water holding container further comprises, operationally installed within, a plurality of precious metal harvesting probes enabling a collection of precious metals.

3. The apparatus of claim 1 further comprising a plurality of battery storage devices enabling an electrical power storage.

4. The apparatus of claim 1 further comprising
a plurality of renewable power sources,
a plurality of battery storage devices,
a plurality of water holding containers having installed within a plurality of electrolysis cells, a plurality of precious metal harvesting probes, a filtration system, and a settlement pond,
a plurality of chlorine scrubbers,
a plurality of hydrogen tanks,
a plurality of chlorine tanks,
a plurality of hydrogen combustion engines,
a plurality of water tanks,
a plurality of electricity generators,
a plurality of transformers, and
a plurality of electrical transfer switches
enabling a scalable electric power supply to be produced wherein said water holding container is filled with a volume of ocean water equal to more than half of the volume of said water holding tank enabling an electrolysis of said ocean water and chlorine scrubbing to produce hydrogen enabling the operation of said hydrogen combustion engine thereby operating said electricity generator to produce, transform, switch an electric power supply herein produced.

5. The apparatus of claim 4 wherein said hydrogen combustion engine is instead a hydrogen turbine enabling said electric power supply and a heat source to increase efficiency of said filtration system and said settlement pond.

6. A method of using a ParaDice System to generate a renewal electrical energy for a home comprising the interconnection of
a plurality of renewable power sources,
a plurality of battery storage devices,
a plurality of water holding containers having installed within a plurality of electrolysis cells, a plurality of precious metal harvesting probes, a filtration system, and a settlement pond,
a plurality of chlorine scrubbers,
a plurality of hydrogen tanks,
a plurality of chlorine tanks,
a plurality of hydrogen combustion engines,
a plurality of water tanks,
a plurality of electricity generators,
a plurality of transformers, and
a plurality of electrical transfer switches
which thereby enables a scalable electric power supply to be produced wherein said water holding container is filled with a volume of ocean water equal to more than half of the volume of said water holding tank enabling an electrolysis of said ocean water and chlorine scrubbing to produce hydrogen enabling the operation of said hydrogen combustion engine thereby operating said electricity generator to produce, transform, switch an electric power supply herein produced.

7. The method of claim 6, wherein said home is instead a business electrically powered by said apparatus.

8. The method of claim 6, wherein said home is instead a hydroponic grow house electrically powered by said apparatus.

9. The method of claim 6, wherein said home is instead a military base electrically powered by said apparatus.

10. The method of claim 6, wherein said home is instead a refuge camp electrically powered by said apparatus.

11. The method of claim 6, wherein said home is instead an island nation electrically powered by said apparatus.

12. The method of claim 6 further comprising a method to use chlorine comprising pumping of chlorine from said chlorine tank to a chlorine consumption.

13. The method of claim 6 further comprising a method to use potable water comprising pumping potable water from said water tank to a water consumption.

14. The method of claim 6 further comprising a method to create precious metals comprising harvesting precious metals from said precious metal harvesting probes.

15. The method of claim 6 further comprising a method to create salt comprising harvesting salt from said settlement pond to a salt consumption.

16. The method of claim 6 further comprising a method to create hydrogen comprising pumping of hydrogen from said hydrogen tank to a hydrogen consumption.

17. The method of claim 6 instead used to provide live load stand-by/back-up electrical power.

18. The method of claim 6 instead used to provide stand-by/back-up electrical power to a battery storage device.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. A method of carbon emission free energy generation and storage, including utilizing a power source to generate electricity carbon emission free, providing the electricity to an ocean water electrolysis apparatus to produce a mixture of hydrogen and chlorine, channeling the mixture to a chlorine scrubber to separate the hydrogen and chlorine, and providing the chlorine and hydrogen separately to chlorine storage tank and a hydrogen storage tank including providing the hydrogen as a fuel to an internal combustion or turbine engine to generate power.

31. The method of carbon emission free energy generation and storage according to claim 30 including providing heat from the internal combustion or turbine engine to a water container to warm the ocean water inside.

32. The method of carbon emission free energy generation and storage according to claim 30 including utilizing the internal combustion or turbine engine to drive an electricity generator.

33. The method of carbon emission free energy generation and storage according to claim 30 including opening a hydrogen use line intermediate the hydrogen storage tank and the internal combustion or turbine engine to provide the hydrogen.

34. (canceled)
